(19) United States
(12) Patent Application Publication
(10) Pub. No.: US 2023/0042180 A1
(43) Pub. Date: Feb. 9, 2023

(54) HIGH-TEMPERATURE SHAPE MEMORY PHOTOPOLYMERS AND METHODS OF MAKING

(71) Applicant: Board of Supervisors of Louisiana State University and Agricultural and Mechanical College, Baton Rouge, LA (US)

(72) Inventors: Xiaming Feng, Baton Rouge, LA (US); Guoqiang Li, Baton Rouge, LA (US)

(21) Appl. No.: 17/957,724

(22) Filed: Sep. 30, 2022

Related U.S. Application Data
(60) Provisional application No. 63/201,797, filed on May 13, 2021.

(51) Int. Cl. C08F 120/12

(52) U.S. Cl. CPC C08F 120/12

(57) ABSTRACT

Provided herein are high-temperature shape memory photopolymers (HTSMP) and methods of making. The HTSMP has flame retardance and recovery stress of greater than 30 MPa. The HTSMP is formed from a polyacrylate and about 5 wt % to 15 wt % of a phosphorus containing photo-initiator (TPO), wherein the polyacrylate is polymerized by UV exposure of an acrylate monomer and the TPO.

### CROSS-REFERENCE TO RELATED APPLICATIONS

This application claims the benefit of and priority to U.S. Provisional Application Ser. No. 63/201,797, having the title “High-temperature shape memory photopolymer with intrinsic flame retardancy and record-high recovery stress”, filed on May 13, 2021, the disclosure of which is incorporated herein by reference in its entirety.

### STATEMENT REGARDING FEDERALLY SPONSORED RESEARCH OR DEVELOPMENT

This invention was made with Government support under contracts 1946231 and 1736136 awarded by the National Science Foundation and by contract NNX16AQ93A awarded by the National Aeronautics and Space Administration. The Government has certain rights in the invention.

### BACKGROUND

Photopolymers have been widely used in 3D printing structures with high resolution by technologies such as digital light processing (DLP). However, a bottleneck persists in the lack of photopolymer inks integrated with high glass transition temperature (T_{g}), flame-retardancy, and high recovery stress, which are highly desired in several sectors such as in the aerospace, automotive, construction, oil & gas, and electronic industries. In addition, photopolymers usually have low mechanical strength and toughness, limiting their use in critical load-bearing structures.

### SUMMARY

Embodiments of the present disclosure provide HTSMP compositions, methods of making HTSMP, methods of use, products including HTSMP and the like.

An embodiment of the present disclosure includes a high-temperature shape memory photopolymer (HTSMP) that includes polyacrylate and a phosphorus containing photo-initiator (TPO), wherein the polyacrylate is polymerized by UV exposure of an acrylate monomer and the TPO, and wherein the HTSMP comprises about 5 wt % to 15 wt % of TPO.

An embodiment of the present disclosure also includes a method of making a high-temperature shape memory photopolymer. The method includes combining an acrylate monomer and a phosphorus containing photo-initiator (TPO) to form a mixture, curing the mixture under UV light to form a polyacrylate, and heating the polyacrylate.

Other compositions, apparatus, methods, features, and advantages will be or become apparent to one with skill in the art upon examination of the following drawings and detailed description. It is intended that all such additional compositions, apparatus, methods, features and advantages be included within this description, be within the scope of the present disclosure, and be protected by the accompanying claims.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1A provides the chemical structures of acrylate monomer and photo-initiator, photo of the high temperature shape memory polymer (HTSMP) slice, and schematic illustration of the two-step curing process as described herein. The shaded triangle shape indicates a thermally stable isocyanurate ring; the small flags indicate photopolymerizable acrylate structures; the shaded rectangle shape means multipurpose photo-initiator; and the solid line means polymerized polyolefin chain. FIG. 1B shows the free radical polymerization mechanism of acylates upon exposure to UV light in accordance with embodiments of the present disclosure. FIG. 1C provides FTIR spectra of the TAI monomer and the samples prepared under different curing conditions (RT: room temperature). FIG. 1D shows the carbon-carbon double bond conversion ratios, and FIG. 1E shows DSC heat flow curves of different samples. FIG. 1F shows the stress relaxation curve of the 40 s and 180 s UV cured samples at 280° C.

FIG. 2A is a graph of the storage modulus. FIG. 2B shows tan delta curves of the samples prepared through different curing conditions. FIG. 2C shows room temperature tensile and FIG. 2D shows room temperature compressive stress-stain curves of the samples prepared through different curing conditions.

FIG. 3A provides the fully constrained stress recovery profile of the HTSMP in accordance with embodiments of the present disclosure. FIG. 3B shows the relationship between the recovery stress and recovery strain. FIG. 3C provides a comparison of the recovery stress and T_{g} value with those of previously reported SMPs (the hollow circle means pure SMPs; the solid square means SMP (nano)composites).

FIG. 4A is an image of the HTSMP slice before and after heating at 200° C. for 1 h with a load of 90 g on top, in accordance with embodiments of the present disclosure. TG and DTG curves of the HTSMP under (FIG. 4B) inert argon and (FIG. 4C) air atmospheres. FIG. 4D shows a TG curve of the HTSMP isothermal at 300° C. for 3 h.

FIGS. 5A-5D are camera images showing vertical combustion performances of the (FIG. 5A) TAI/HMP-7, (FIG. 5B) BisGMA/TPO-7, (FIG. 5C) TAI/TPO-3, and (FIG. 5D) HTSMP samples.

FIG. 6A is an SEM image and FIG. 6B is EDS data of the char residue of the HTSMP. High-resolution (FIG. 6C) C 1s, (FIG. 6D) O 1s, (FIG. 6E) N 1s, and (FIG. 6F) P 2p XPS spectra of the char residue of the HTSMP.

FIG. 7 provides camera images of a 3D printed cylinder sample before (left) and after (right) thermally post-curing.

FIGS. 8A-8B are FTIR spectra of the TAI monomer and the samples prepared under different curing conditions (FIG. 8A). DSC heat flow curve of the TAI monomer (FIG. 8B).

FIG. 9 shows the storage modulus and tan delta profiles of the 40 s UV cured sample after stress relation test. The sample was broken when the temperature was around 350° C.

FIGS. 10A-10B show the compressive stress-stain curves of the 40 s UV cured sample (FIG. 10A) and the HTSMP sample (FIG. 10B) at elevated temperatures.

FIG. 11A is a camera image of the programming and shape recovery cycle of the 40 s UV cured sample. FIG. 11B shows the fully constrained stress recovery profile of the 40 s UV cured sample.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, material science, and the like, which are within the skill of the art.

The following examples are put forth so as to provide those of ordinary skill in the art with a complete disclosure and description of how to perform the methods and use the compositions disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

As used herein, the following terms have the meanings ascribed to them unless specified otherwise. In this disclosure, “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. patent law and the term is open-ended, allowing for the presence of more than that which is recited so long as basic or novel characteristics of that which is recited is not changed by the presence of more than that which is recited, but excludes prior art embodiments.

### Definitions

Photopolymers, as used herein refer generally to imaging compositions based on photo initiators/oligomers/monomers which can be selectively polymerized and/or crosslinked upon image-wise exposure by light radiation such as ultra-violet (UV) light. Photopolymers can be made into different forms including fiber/film/sheet, liquid, solution/mixture etc. which find outlets in printing plates, photoresists, stereolithography/3D printing and imaging, and rubber stamps. Photoresists are used to make integrated circuits, flat panel displays, printed circuits, chemically milled parts, MEMS (microelectromechanical systems) etc. Similar liquid compositions can also be used for non-imaging applications such as adhesives, coatings and inks, and composites. A photopolymer product can be applied as a very thin coating as in liquid photoresists or formed into a large model as in a stereolithographic/3D printing equipment.

Shape memory photopolymer as used herein refers to a shape memory polymer that is cured by ultraviolet light.

High-temperature shape memory photopolymer as used herein is a shape memory photopolymer that has high transition temperature such as high glass transition temperature (above 200° C.), as compared to most thermoset shape memory polymers, which have glass transition temperature lower than 200° C.

### General Discussion

In accordance with the purpose(s) of the present disclosure, as embodied and broadly described herein, embodiments of the present disclosure, in some aspects, relate to high temperature shape memory photopolymers (HTSMP).

In general, embodiments of the present disclosure provide for methods of making HTSMP, compositions including HTSMP, and products including HTSMP.

The present disclosure includes a high-temperature shape memory photopolymer (HTSMP) that includes a polyacrylate and a phosphorus-containing photo-initiator (TPO). The polyacrylate is polymerized by exposing an acrylate monomer and the TPO to ultraviolet (UV). The HTSMP comprises about 5 wt % to 15 wt % of TPO, about 7 wt % to 15 wt %, or about 7 wt % of TPO. Advantageously, the HTSMPs described herein have a high Tg and acceptable flame retardancy without the incorporation of external flame-retardant additives. The flame retardancy as described herein is when the HTSMP is flame retardant at least when exposed to an open flame for 10 seconds twice.

Described herein is an intrinsically flame-retardant high-temperature shape memory photopolymer (HTSMP). Advantageously, the HTSMP has both an ultrahigh glass transition temperature (T_{g}) of about 150° C. to 300° C., about 200° C. to 300° C., or about 280° C. and record-breaking recovery stress (e.g., about 20 MPa to 50 MPa, about 30 MPa to 40 MPa, or about 35.3 MPa). The HTSMP is strong and not brittle, having an elongation at break of about 30% to 40% or about 33%. The HTSMP can have an initial decomposition temperature of greater than about 360° C.

In an embodiment, the HTSMP is made of acylate monomer (TAI) and photo-initiator (TPO). The TPO can generate free radicals under the illumination of UV light. The free radicals can initiate the polymerization of carbon-carbon double bonds in TAI monomer, leading to the conversion by curing of acrylate into polyacrylate (e.g., a photopolymer). The shape memory effect is ascribed to the crosslinked network structure of the polyacrylate, i.e. attributed to the entropic elasticity of polyacrylate at rubber state (above glass transition temperature of polyacrylate). Advantageously, the excess amount of TPO serves as both a photo-initiator and also a functional flame retardant. The TPO also becomes a part of the crosslinked network by grafting onto the polyacrylate chains, providing the desired steric hinderance, together with the stiff TAI monomer, providing the record-high recovery stress. Conventional photo-initiators have not been found to provide a flame retardancy benefit.

In some embodiments, the acrylate monomer comprises a thermally stable isocyanurate structure, including but not limited to isocyanurate, isocyanurate triacrylate, or triglycidyl isocyanurate acrylate.

In some embodiments, the TPO is a phosphine oxide. Embodiments of the present disclosure include a method of making a HTSMP as described above, wherein the HTSMP is formed using a two-step curing method including UV curing followed by heat curing, resulting in shape memory polymer with exceptional high recovery stress. The two-step process transfers the polyacrylate from a brittle polymer to a strong and tough polymer. An acrylate monomer and a phosphorus containing photo-initiator (TPO) are combined to form a mixture. The mixture is cured under UV light to form a polyacrylate. Then the polyacrylate is heated at about 280° C. for about 180 minutes. The heating results in complete polymerization of carbon-carbon double bonds in the acrylate monomer.

In some embodiments, compression can be used during polymerization to eliminate the shrinkage, such as for obtaining sheet-shaped samples.

In some embodiments, the HTSMP is suitable for use in Digital Light Processing (DLP) printing. The polymerization of carbon-carbon double bonds in the photopolymer (e.g. the acrylate monomer) can be achieved under the illumination of UV light in seconds. Under UV irradiation, the TPO photo-initiator will release free radicals, which leads to polymerization of the monomer. 3D printing needs the liquid monomer be (partially) cured instantly to maintain the shape. Therefore, UV curable is a must for printing liquid inks.

In some embodiments, the HTSMP is suitable for use in deployable structures. The polymer can be printed into structures (e.g., the supporting frame for solar panel in a satellite). In a particular example, the SMP-based frame can be folded before take-off to save space. Once it is in space, the shape memory effect can be triggered, and the folded solar panel unfolds to its designed shape.

### Examples

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

Photopolymers have been widely used in 3D printing structures with high resolution by technologies such as digital light processing (DLP). However, a bottleneck persists in the lack of photopolymer inks integrated with high T_{g}, flame-retardancy, and high recovery stress, which are highly desired in several sectors such as in aerospace, automotive, construction, oil&gas, and electronic industries. In addition, photopolymers usually have low mechanical strength and toughness, limiting their use in critical load-bearing structures. In this study, a photopolymerizable isocyanurate triacrylate and a phosphine oxide photo-initiator were firstly formulated to prepare HTSMP through a facile two-step ultraviolet (UV) curing and thermal curing process. The UV curing makes the HTSMP 3D printable. After the unusual high-temperature (280° C. for 3 h) post-curing, the HTSMP network was highly crosslinked and uniform, which enhanced the strength and toughness. Additionally, the synergy between isocyanurate and phosphine oxide contributed excellent thermal stability and high flame-retardancy to the HTSPM, which cannot be ignited upon ten-second ignition for two times. A condensed-phase mechanism for flame-retardancy was also identified. With the ultrahigh T_{g}, record-high recovery stress and energy output, excellent thermal stability, intrinsic flame retardancy, and 3D printability, this new multifunctional HTSMP has a great potential in various applications, such as in deployable structures, damage self-healing, actuators, proppants, sealants, 4D printing, and robotics.

Shape memory polymers (SMPs) have played more and more important role in the technological advancements of aerospace structures, soft robotics, and electronic devices [1, 2]. They can be programmed into temporary dimensions and recover to their permanent shape upon external stimuli such as heat [3, 4], light [5], solvent [6], magnetic fields [7, 8], and electricity [9, 10]. Among the SMPs, thermoset SMPs with glass transition as triggers are extensively studied because they are easier to manufacture and customize. So far, the majority of previous reports focused on the development of various SMPs with relatively low trigger temperature or glass transition temperature (T_{g}) (<200° C.), such as polyurethane [11], poly(ε-caprolactone) [12], and polylactide [13]. However, these conventional SMPs possess low mechanical performance, and cannot meet the urgent requirement in harsh environments that need high trigger temperature or T_{g} (>250° C.), as well as high thermal stability, such as in aerospace and oil drilling [14, 15]. Therefore, it is highly desired to develop high-performance SMPs that have both high T_{g} and excellent thermal stability.

It is well-known that the intrinsic flammability of polymers can lead to rapid fire propagation and heavy loss of property and life, especially in these fields with high fire risk, such as electronics, transportation, and construction industries [16, 17]. In addition to thermal stability, particularly for these high-temperature SMPs (HTSMPs), flame retardancy is much needed. When the HTSMPs are in service, an external heat source is needed to heat the structure over the T_{g}, in order to induce the shape/stress recovery. Additionally, due to the fairly low thermal conductivity, a higher heating temperature is always applied to speed up the shape recovery process. Because the T_{g} of HTSMPs is close to their thermal decomposition temperature, it is very likely to result in thermal runaway and fire accident. Thus, how to improve flame retardancy of the HTSMPs is worthy of study. However, only very few studies were reported to overcome this problem [18, 19]. In our previous study [18], a flame-retardant curing agent was utilized to fabricate flame-retardant SMPs while maintaining the excellent shape memory property. However, the high content of flame-retardant structure obviously decreased the T_{g} and mechanical property. For this reason, it is a great challenge to obtain high performance SMPs with high T_{g} and acceptable flame retardancy simultaneously. Ideas other than incorporation of external flame-retardant additives must be sought.

Besides the shape memory ability, SMPs can generate force when the programmed shape is partially or fully confined. This recovery force can do positive work on the surroundings [20-22]. In some heavy-duty engineering structures, the SMPs with high recovery stress are highly desired, such as using shape recovery force to close macroscopic crack in self-healing applications [23]. However, the recovery stresses of conventional SMPs are only from tenths MPa to several MPa, which are not sufficient to close macroscopic cracks especially when the structure is in-service such as under tensile stress. There are some reports focused on improving the recovery stress by preparing SMP composites [20, 24]. For example, Poulin et al. has reported a polyvinyl alcohol (PVA)-carbon nanotubes (CNTs) nanocomposites fiber with extremely high recovery stress (˜150 MPa) [20]. However, the complicated fabrication of nanocomposite and unidirectional fibrous product heavily limits its wide usage in practical applications. Recently, our group reported an enthalpy-driven SMP, which possesses a recorded high recovery stress of 17.0 MPa and energy output of 2.12 MJ/m³ in rubbery state and in bulk form [21]. It stores energy through enthalpy increase by bond length change and bond angle change during programming [25, 26]. However, the T_{g} of this enthalpy-driven SMP is only 150° C. and it is still flammable, which restricts its potential application in these high T_{g} demanding fields with high fire risk. Furthermore, this polymer is not UV curable and thus cannot be printed by DLP. Therefore, the motivation of this study was to develop high-performance HTSMPs with intrinsic flame retardancy, high recovery stress, and 3D printability, which can be applied not only to these typical fields where fire hazard and load-bearing are concerned, but also to some emerging and crossing fields, such as deployable structures, actuators, damage self-healing, robotics, proppants, and 4D printing. Indeed, shape memory polyimides usually have high T_{g}, good mechanical property and flame retardancy. However, shape memory polyimides are not UV curable, and thus cannot be printed by high resolution DLP. Furthermore, the recovery stress of shape memory polyimides is only on the average level (<20 MPa) [24], demonstrating the limitation in critical load-bearing fields.

In this study, to synthesize HTSMP, a UV curable triacrylate monomer with thermally stable isocyanurate ring was used to construct a highly crosslinked network. An excess amount of commercially available phosphine oxide was firstly applied not only as the photo-initiator to achieve UV curability but also as the flame-retardant structure to improve flame resistance of the resulting HTSMP, and also to provide steric hinderance to achieve high recovery stress. Different from the conventional phosphorus-containing flame retardants, such as phosphate, phosphine oxide is extremely stable to thermal and hydrolyzation. Due to the lower bond energy, the P—C bond is broken just before the C—C bond breaks [27, 28]. Therefore, the UV cured HTSMP can endure thermally post-curing at 280° C. for 3 h to achieve fully polymerization of the acylate monomer. Benefitted from the resulting highly crosslinked and uniform network, the HTSMP exhibited an ultrahigh T_{g} (280° C.) and promising high temperature mechanical properties, as well as a record-breaking shape recovery stress (˜35.3 MPa). Additionally, the synergistic effect between isocyanurate ring and phosphine oxide structure endowed the HTSMP with acceptable flame retardancy. The detailed flame-retardant mechanism was also discussed through characterization of the char residue. The synergistical combination of acrylate monomer and photo-initiator proposed herein may motivate further studies on developing high-performance multifunctional photopolymers.

Tris[2-(acryloyloxy)ethyl] isocyanurate (TAI) and photo-initiator Diphenyl(2,4,6-trimethylbenzoyl)phosphine oxide (97%) (TPO), 2-hydroxy-2-methylpropiophenone (97%) (HMP), and Bisphenol A glycerolate dimethacrylate (BisGMA) were purchased from Sigma-Aldrich and used as received.

93 wt % tris[2-(acryloyloxy)ethyl] isocyanurate monomer and 7 wt % photo-initiator diphenyl(2,4,6-trimethylbenzoyl)phosphine oxide was mixed at 100° C. and degassed in a vacuum oven. The clear liquid was poured into a PTFE spacer with thickness of 1.1 mm clamped by two transparent plastic slides. The mixture was then cured in a UV chamber (IntelliRay 600, Uvitron International, USA) for 40 s under 35% irradiation intensity (232 nm, ˜45 mW/cm²). The UV cured sample was then thermally post-cured in an oven at 280° C. for different time durations. The TAI monomer with 7 wt % conventional 2-hydroxy methylpropiophenone (HMP) photo-initiator, TAI monomer with 3 wt % (usual dose) TPO photo-initiator, and conventional bisphenol A glycerolate dimethacrylate (BisGMA) monomer with 7 wt % TPO photo-initiator were also prepared following the same procedure, and were abbreviated as TAI/HMP-7, TAI/TPO-3 and BisGMA/TPO-7, respectively. These polymers will be used as controls for flame retardancy tests.

Fourier Transform Infrared Spectroscopy (FTIR) spectra were collected by a Nicolet 6700 FTIR spectrometer (Thermo Fisher Scientific, USA) in attenuated total reflection mode by collecting 32 scans from 500 to 4000 cm⁻¹. Thermal behavior was studied through a PerkinElmer 4000 differential scanning calorimeter (DSC) (MA, USA). Samples (5-10 mg) were heated and cooled at a linear heating/cooling rate of 10° C. min⁻¹; the holding time at the end of heating or cooling was 3 min. The purging rate of nitrogen gas was 30 mL min⁻¹. Dynamic mechanical performance was evaluated by a Q800 dynamic mechanical analyzer (DMA) (TA Instruments, DE, USA) in multifrequency strain mode with a heating rate of 3° C. min⁻¹, and a frequency of 1 Hz. Non-isothermal thermogravimetric analysis (TGA) tests were performed by Q5000 thermal analyzer (TA Co., USA) from 30 to 800° C. at a heating rate of 10° C./min in both argon and air environments. For isothermal test, the sample was rapidly heated from 30 to 300° C. at a heating rate of 100° C./min in argon atmosphere, then isothermal for 3 hours. The purging rate of the argon gas was 100 mL min⁻¹. The morphology of char residue obtained from flame retardancy test was monitored by a scanning electron microscope (SEM) (JSM-6610 LV, JEOL, USA). The accelerating voltage was 15 kV. The X-ray photoelectron spectroscopy (XPS) spectra were carried out by the Scienta Omicron ESCA 2SR X-ray Photoelectron Spectroscope. The tensile and compression properties were evaluated by using an eXpert 2610 MTS (ADMET, Norwood, Mass., USA) equipped with a temperature-regulated oven. As for the compression test, the compression rate was 0.5 mm/min. As for the tensile test, the stretching rate was 1.0 mm/min. At least three samples were used for the mechanical test.

The shape memory properties were tested according to our previous report [18]. In brief, the cylinder specimen (˜6 mm of diameter, ˜9 mm of height) was placed in between the MTS clamps and thermally equilibrate at 275° C. for 1 h. Then the cylinder was compressed to a certain stain at a speed of 0.5 mm/min and maintained for 10 min. After that, the compressed cylinder was rapidly cooled to room temperature by spraying water, followed by load removal. The height of the programmed specimen was recorded to figure out shape fixity ratio. The free shape recovery experiment was conducted by putting the programmed specimen in an oven at 275° C. for 60 min. The height of the recovered specimen was measured to calculate shape recovery ratio.

The recovery stress was measured according to our previous report [29]. First, the MTS fixtures were pre-heated in the attached oven (275° C., 1 h) so that the thermal expansion of the metal fixtures can be avoided. Then 20% compressive strain programmed HTSMP cylinder was rapidly confined between the fixtures in partial (under different recovery strains) or in full (under zero recovery strain). The force data were recorded as a function of time. The energy output was calculated based on the area under the curve of recovery stress and recovery strain.

The flame retardancy of the acrylate thermosets was evaluated through a simple vertical burning experiment. The size of the rectangular sheet samples was set as 125×13.5×3.2 mm³ according to the UL-94 standard for safety of flammability of plastic materials. The specimen was vertically clamped by a metal clip and then ignited by a gas lighter for 10 s. For the HTSMP samples, another ten-second ignition was applied after the first ten-second ignition. The whole combustion processes were recorded by a camera. The char residue of HTSMP sample was collected for further characterization.

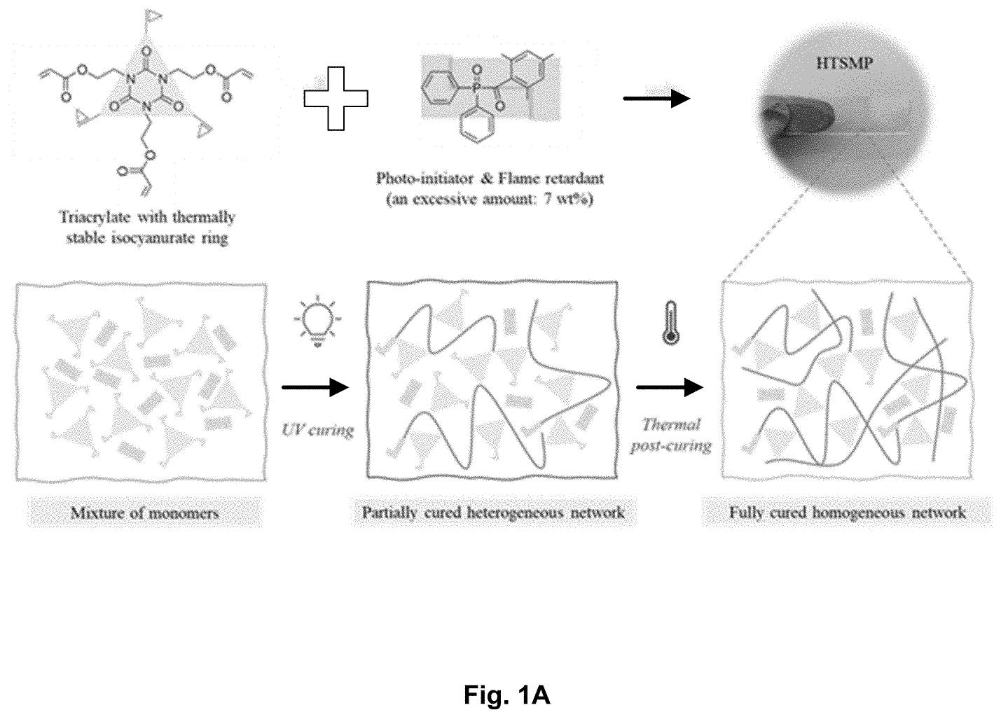

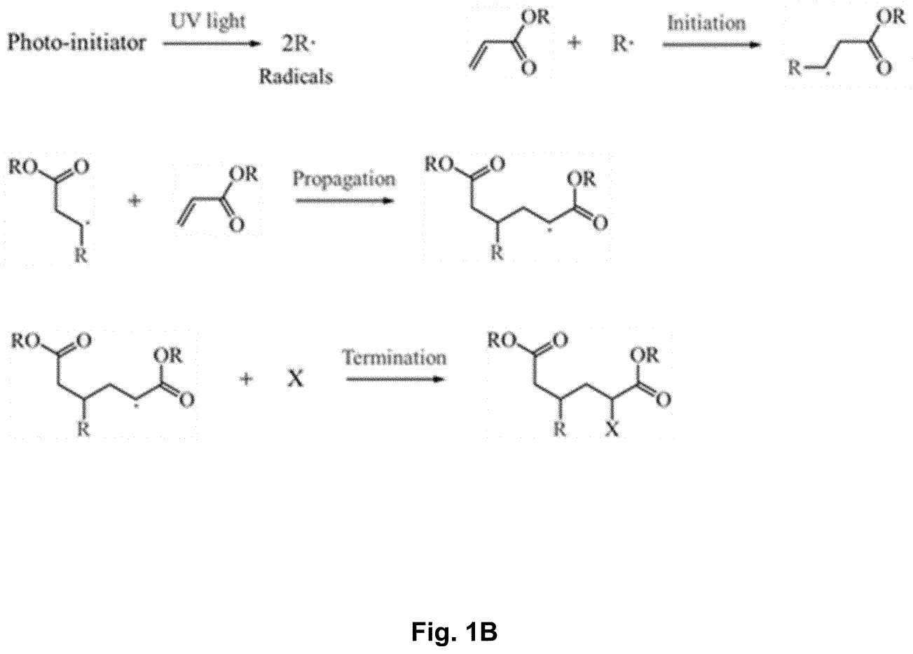

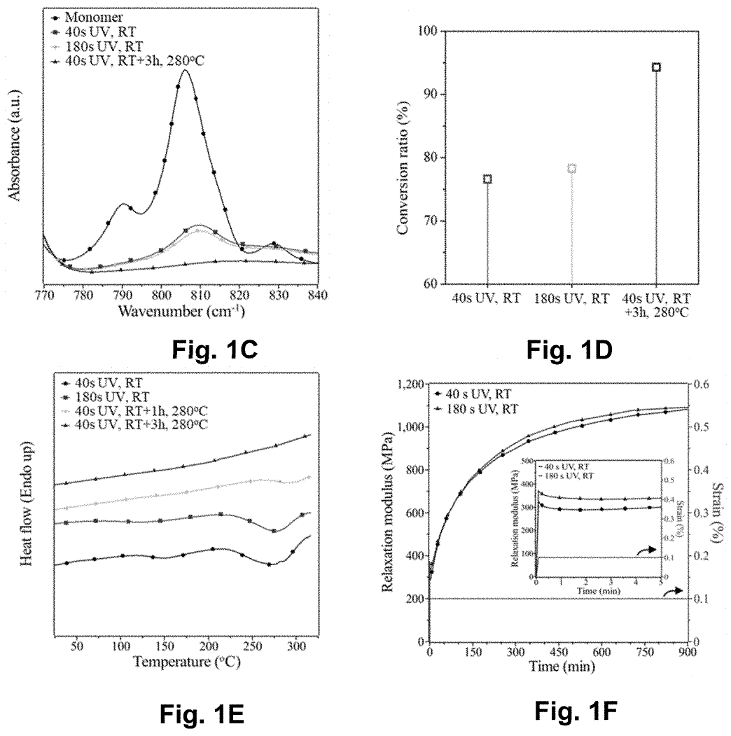

It is well-known that the short-time UV exposure alone cannot completely cure acrylate monomers. The obtained polyacrylates always show broad glass transition region and brittleness due to the heterogeneous network and residue internal stress [30, 31]. This broad glass transition region is a major drawback for rapid shape recovery of glass transition induced SME. As shown in FIG. 1A, to obtain high-performance HTSMP, an acrylate monomer with thermally stable isocyanurate structure (TAI) and a phosphorus containing photo-initiator (TPO) were formulated. An excessive amount (7 wt %) of the TPO was incorporated to endow the resulting HTSMP with high thermal stability and flame retardancy. As shown in FIG. 1B, during the UV exposure, the photo-initiator can cleave into radicals, which could initiate the polymerization of acrylate to form polyacrylate in seconds. Following the initiation, the cleaved units would attach on the molecular chains of polyacrylate. This suggests that the flame retardant structure of the TPO is covalently grafted onto the polyacrylate network. The problems of migration and damage to mechanical properties by the incorporation of flame retardant in conventional polymers can be completely avoided in this HTSMP. An extraordinarily high-temperature post-curing process (280° C. for 3 h) was performed to make the carbon-carbon double bonds (C═C) in acrylates fully polymerize and the internal stress be removed. Through thermally post-curing, the crosslinking density is increased and the network becomes more homogeneous. The as-prepared HTSMP has a high transparency (Inset in FIG. 1A), indicating its potential application in transparency-concerned fields. Moreover, this HTSMP can be digital light printable through simply controlling the viscosity upon heating. The melting temperature of acrylate monomer is around 55° C. By heating to about 90° C., the viscosity is reduced.

The HTSMP and prepared syntactic foam (adding 40% by volume of hollow bubbles to the polymer). Viscosity of the foam was measured under the change of either temperature or shear rate. The viscosity of the foam changes from several thousands of Pas to several tenths of Pas. The result is printable not only by a DLP type of printer, but also by an extrusion type of printer.

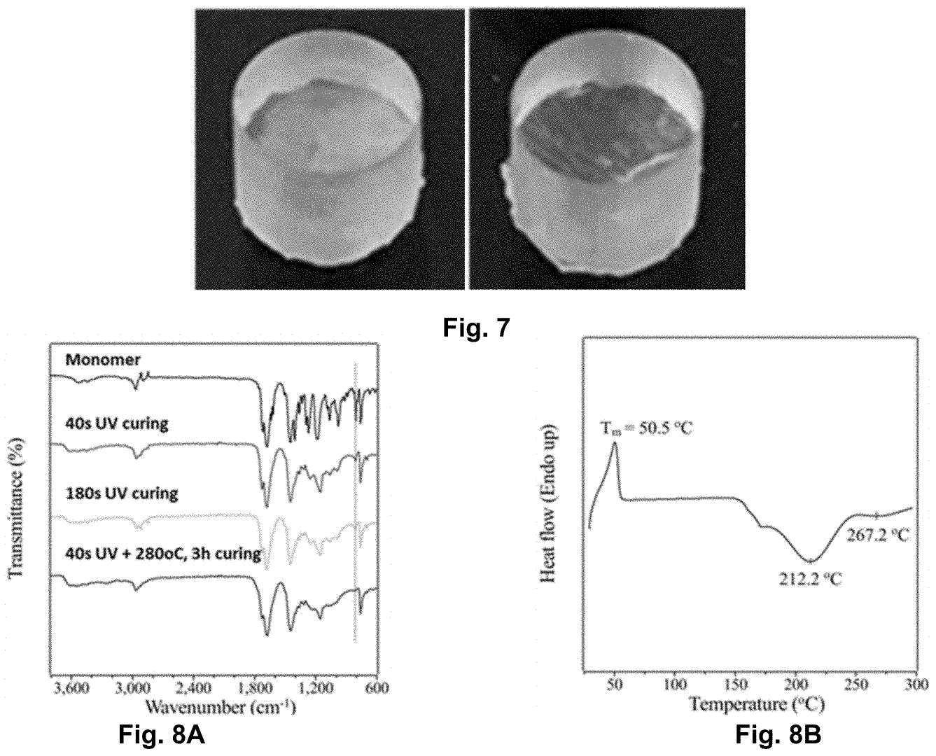

FIG. 7 shows the 3D printed cylinders before and after various post-curing processes. No dimensional shrinkage or cracks can be seen, which indicates good dimensional stability.

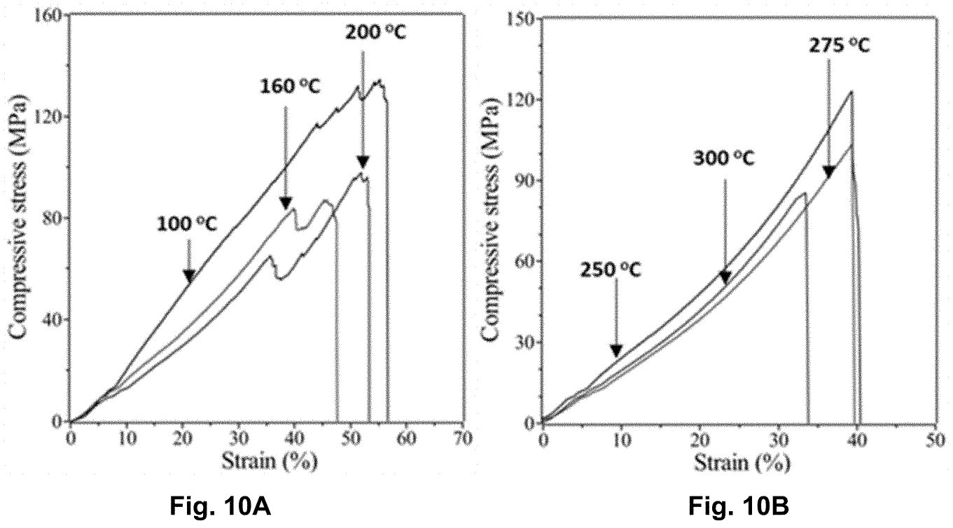

FTIR spectra were employed to monitor the conversion of C═C groups after various curing conditions. FIG. 10 displays the comparison of the absorption peak around 810 cm⁻¹ of C═C groups. After 40 s UV curing, the peak intensity is much decreased, indicating polymerization of the majority of C═C groups. When extending the UV exposure to 180 s, the peak intensity slightly decreased. However, it still demonstrated that the C═O groups cannot be completely converted even the exposure time is much increased. Notably, the absorption peak of the C═C double bonds for the two-step cured sample almost disappeared, suggesting the sample was fully cured. The conversion ratios of C═C groups were calculated by the absorption peak area ratio of the cured sample to that of monomer and are depicted in FIG. 1D. Both 40 seconds and 180 seconds UV cured samples show the conversion ratios lower than 80%, while the two-step cured sample reached to 94.3%, demonstrating that the C═C groups were almost fully reacted. Furthermore, the similar FTIR spectra before and after post-curing process confirm that no obvious thermal decomposition occurred (FIGS. 8A-8B). The same conclusion can be observed by the DSC profiles (FIG. 1E). An obvious exothermic peak (˜280° C.) attributed to thermal polymerization of C═C groups was observed for UV cured samples. The exothermic peak decreased as the thermal post-curing time increases, and disappeared in the DSC profile of the HTSMP sample. This result suggests that the acceptable thermal post-curing condition is at 280° C. for 3 h.

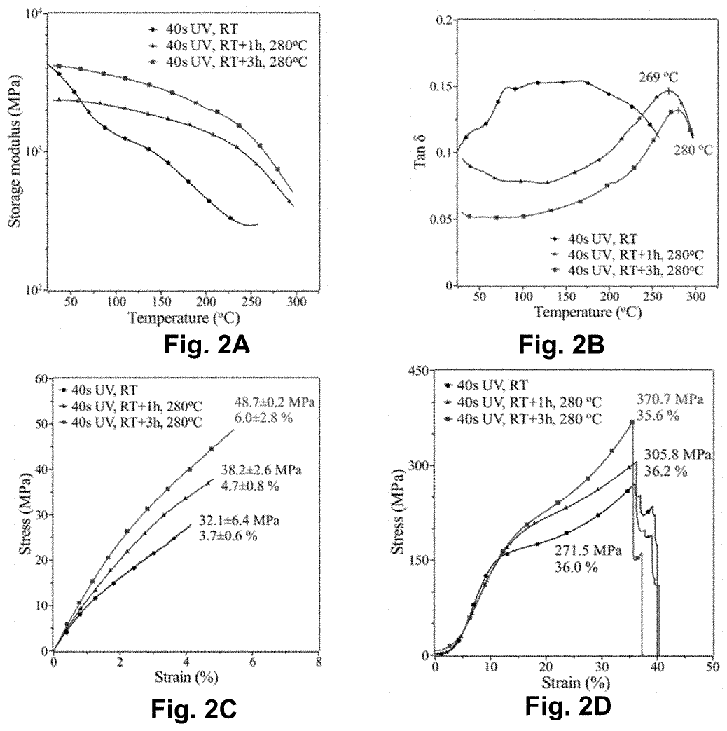

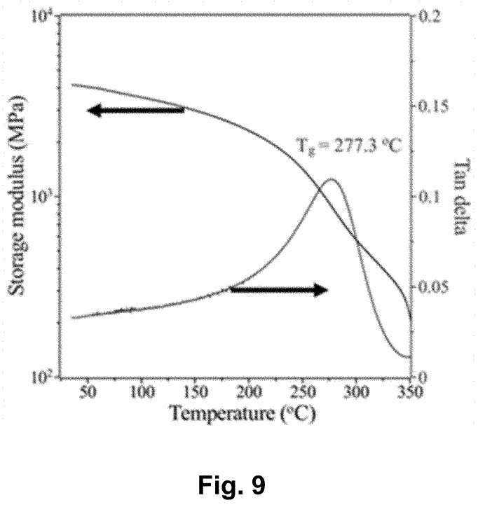

The stress relaxation experiment at 280° C. was conducted to monitor the polymerization process of the UV cured sample during thermal post-curing. Here we set the constant tensile stain to be only 0.1% to make sure the network structure is not much deformed. The stress and relaxation modulus over time were recorded. As shown in FIG. 1F, the relaxation modulus of the two samples started decreasing and then abnormally increasing, which is different from the conventional stress relaxation profile. This increase in relaxation modulus is attributed to the formation of denser network caused by the subsequent thermal polymerization of the remaining C═C groups after UV curing. We can see that the relaxation modulus increased rapidly at the first 3 hours (180 minutes) and gradually stabilized, which is in agreement with the FTIR and DSC results. The final relaxation modulus of the two samples were almost the same, indicating the complete polymerization of the remaining C═C groups after subsequent thermal curing, although the initial UV curing time is different. After the stress relaxation experiment, the dynamic mechanical performance of the 40 s UV cured sample was evaluated, as shown in FIG. 9. The T_{g} is 277.3° C., which is almost the same as that of the HTSMP (FIG. 2A). The comparison for storage modulus and tan δ vs. temperature of the UV cured sample and the HTSMP sample was displayed in FIGS. 2A-2B. The storage modulus suggests the elastic response of the polymer and the tan δ peak demonstrates the glass transition region. The increase in the thermal post-curing time from 0 to 3 h leads to a gradual increase in the storage modulus over a wide temperature range, indicating an increase in stiffness. The shifts of the tan δ peak to a higher temperature is caused by the restricted segmental chain mobility of the highly crosslinked network.

FIG. 2C displays the tensile stress-tensile strain curves of the specimens prepared through different curing conditions. All samples show a typical brittle rupture behavior of thermoset polymers. The tensile strength and ultimate elongation of the UV cured sample at room temperature are 32.1 MPa and 3.7%, while the two-step cured sample exhibited an obviously higher tensile strength and a higher ultimate elongation. The tensile strength and ultimate elongation of HTSMP after 3 h thermal post-curing reach 48.7 MPa and 6.0%, respectively. Generally, the toughness can be estimated based on the area enclosed by the stress-strain curve. It was much increased (˜140%) after the post-curing process. The improvements in tensile strength and Young's modulus can be explained by the more rigid and more densely crosslinked network after thermal post-curing. The reason for the increase in the elongation at break or toughness could be due to the more uniform network, which can distribute and sustain the external force uniformly, less likely to result in stress concentration. The compressive behaviors at room temperature were studied to further illustrate the effect of post-curing. As shown in FIG. 2D, the samples experienced an almost linear elasticity until yielding, flowed by slight plastic follow, and ended up with strain hardening and fracture. Similarly, the compressive strength is much increased from 271.5 to 305. 8 MPa after thermal post-curing at 280° C. for one hour, and to 370.7 MPa after thermal post-curing at 280° C. for three hours, which are higher than those of conventional thermoset polymers. The compression tests were also conducted at high temperature to study the high temperature mechanical properties (FIGS. 10A-10B). Obviously, the compressive profiles at high temperature are different from those at room temperature. No yield point can be observed, and the compressive strength decreased steadily as the testing temperature increased. The compressive strength of the UV-only cured sample (40 s) is around 65 MPa at 200° C., while the compressive strength of the HTSMP subjected to high temperature post-curing is more than 80 MPa at 300° C. This excellent high temperature mechanical property is ascribed to the uniform network with high T_{g} value. Furthermore, the corresponding elongation at break is 33%, suggesting a commendable compressibility of the HTSMP at rubbery state, as well as stress recovery property.

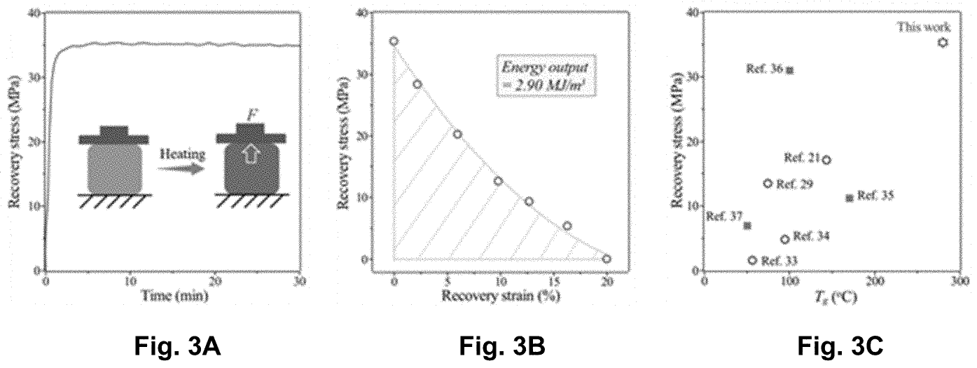

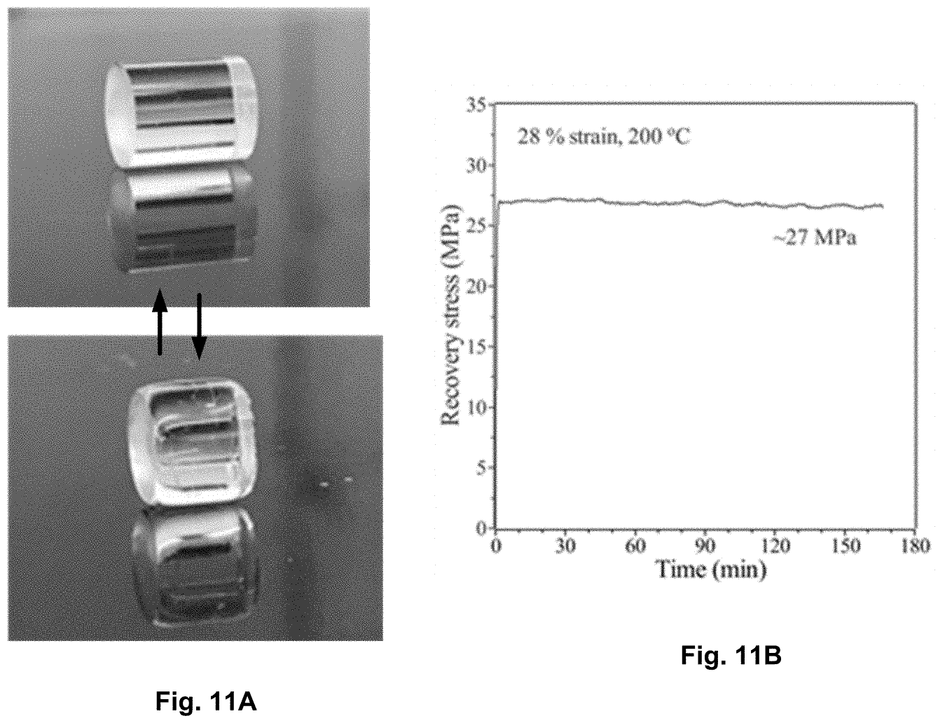

Because the HTSMP exhibited a good deformability in compression mode, the shape memory properties were evaluated in compressive deformation mode. For the programming process, the HTSMP cylinder (˜6.0 mm of diameter) was compressed to ˜35% at 275° C. and maintained for 10 min to achieve stress relaxation. The sample was then rapidly cooled down to room temperature by spraying water while keeping the compressive deformation. After load removal and spring-back, about 20% compressive strain was memorized, which is comparable to the conventional shape memory thermosets [29]. The shape fixity ratio is calculated to be 58.0% (Table 1). The shape recovery ratio was figured out to be 93.1% through free recovery test at the same temperature of 275° C. It suggests that the HTSMP can almost recover to its original shape under free recovery. The stress recovery performance was characterized by fully constraining the cylinder sample with 20% memorized compressive strain. The profile of recovery stress vs. time is shown in FIG. 3A. The recovery stress rapidly increased to ˜35 MPa in several minutes and remained stable for at least 30 min. The maximum recovery stress is as high as 35.3 MPa, which has never been reported in previous reports. As a contrast, the maximum recovery stress of the sample cured by UV alone with 28% compressive programming stain is ˜27 MPa at 200° C. (FIGS. 11A-11B), which is obviously lower than that of the HTSMP.

TABLE 1
Summary of shape memory characteristic parameters
of the 40 s UV cured sample and the HTSMP sample.

| | Fixity ratio | Recovery ratio | Recovery strength |
|---|---|---|---|
| Sample | (%) | (%) | (MPa) |
| 40 s UV cured | 79.0 | 98.6 | 27.0 at 28% strain |
| HTSMP | 58.0 | 93.1 | 35.3 at 20% strain |

The relationship between recovery stress and recovery strain was studied through partially constrained shape recovery experiments, as displayed in FIG. 3B. Obviously, the recovery stress reduced as the recovery strain increased. The energy output of the HTSMP can be calculated from the area enclosed by the recovery stress-recovery strain profile, which reaches up to 2.9 MJ/m³. This is much higher than our previously reported record value [21], and is even comparable to some shape memory alloys [21, 32]. These record-high recovery stress and energy output are primarily attributed to the thermally stable and highly crosslinked network with rigid triazine and aromatic rings. To illustrate the advancement, FIG. 3C depicted the comparison of the maximum recovery stress and T_{g} value of the HTSMP with those of previously reported SMPs [21, 29, 33-37]. We can see that the maximum recovery stress and T_{g} value of most SMPs and even composites are lower than 20 MPa and 200° C., respectively. Indeed, some SMPs with T_{g} more than 200° C. have been reported, such as polyimide [38, 39], poly(ether ether ketone) [40], and cyanate resin [41]. However, their recovery stress is still a fairly general value (<20 MPa) [24]. Notably, our HTSMP is the first one which possess ultrahigh T_{g} and recovery stress at the same time, which certainly can meet the critical requirements for heavy load-bearing engineering structures demanding high recovery temperature.

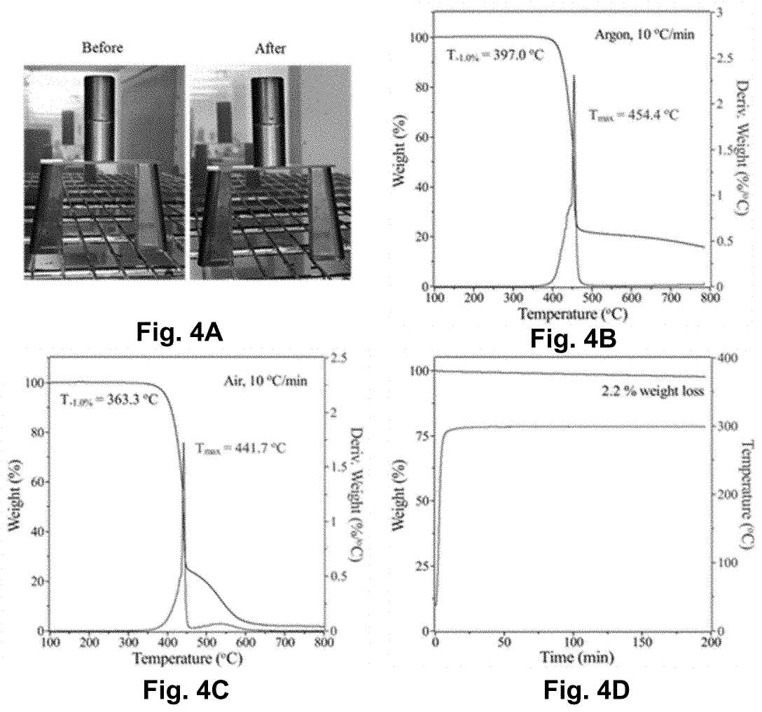

Polymers with high T_{g} value always mean that they can maintain their dimensions and mechanical performance at elevated temperatures. FIG. 4A shows the image of the HTSMP slice (˜1.1 mm of thickness) before and after heating at 200° C. for 1 h with a load of 90 g on top (˜2.4 MPa of bending stress). Obviously, no bending or color change of the HTSMP sample can be observed, which suggests good structural stability at high temperature. Besides, the thermal stability of the HTSMP was studied under inert argon atmosphere in non-isothermal mode, as shown in FIG. 4B. The initial decomposition temperature corresponding to 1% weight loss can reach about 400° C., and the temperature corresponding to the maximum weight loss rate is 454.4° C., which is much higher than those of the conventional photopolymers. The char residue at 600° C. is about 20 wt %, which indicates good charring ability and flame retardancy. Furthermore, the thermal oxidative stability of the HTSMP was characterized under air atmosphere in isothermal and non-isothermal modes, respectively. We can see that the initial decomposition temperature under air atmosphere is still higher than 360° C., while those of most photopolymers are lower than 300° C. [42, 43]. The temperature corresponding to the maximum weight loss rate is up to 441.7° C. Different from under inert atmosphere, the decomposition of the HTSMP under air consists of two major stages. The first stage at 350-450° C. corresponds to the degradation of acylate and alkyl chain structures, and the formation of decomposed cross-link products; while the second one at 450-600° C. is attributed to the decomposition of triazine ring and final carbonization. It demonstrates that the HTSPM is stable under the attacks from thermal and oxygen species. TG curve of the HTSMP isothermal at 300° C. for 3 h was recorded to further illustrate the thermal oxidative stability. As shown in FIG. 3D, after heating at 300° C. for 3 h, only 2.2% weight loss can be monitored, which includes a portion of absorbed water. All these results state that the HTSMP possesses excellent thermal stability and thermal oxidative stability due to the thermally stable triazine ring and aromatic structures [44], which suggests that the sample is difficult to ignite and of high flame retardancy.

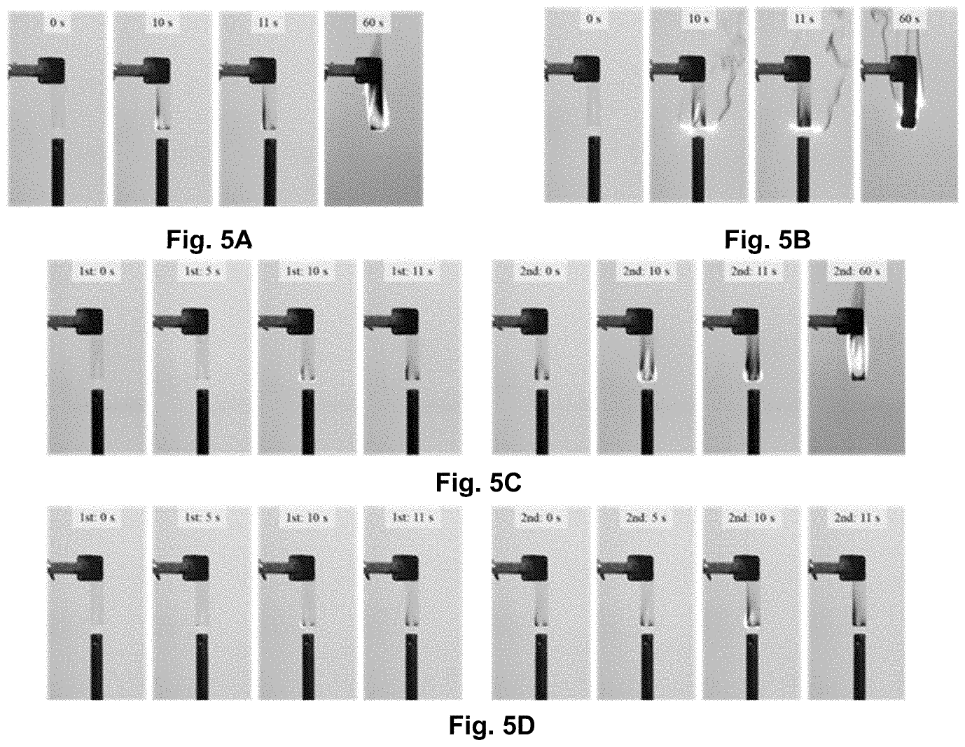

To illustrate the flame retardancy due to the synergy between TAI monomer and TPO photo-initiator, we set TAI/HMP-7, BisGMA/TPO-7, and TAI/TPO-3 as control samples, in which the HMP and BisGMA are widely used photo-initiator and conventional epoxy acrylate monomer, respectively. The 3 wt % of TPO in TAI/TPO-3 sample is the most commonly used content. FIG. 5A shows the ignition and burning process of the TAI/HMP-7 specimen. The vertical sample continued burning after 10 s ignition and burnt out finally. The BisGMA/TPO-7 sample exhibited a similar combustion behavior, as displayed in FIG. 5B. These results indicate that the sample with only TAI monomer or TPO photo-initiator cannot achieve an acceptable flame retardancy. As a contrast, the TAI/TPO-3 cannot be ignited in the first 10 s ignition process (FIG. 5C), demonstrating good thermal oxidative stability. However, during the second process with 10 s ignition, the TAI/TPO-3 specimen was ignited and also burnt out finally. It suggests that the addition of 3 wt % TPO can make the sample with a certain degree of flame retardancy but cannot reach the desired level. FIG. 5D displays the two consecutive ignition processes with each process of 10 s ignition for the HTSMP with 7 wt % TPO. We can see that the HTSMP sample cannot be ignited in the first 10 s ignition process, and immediately extinguished after removing the lighter in the second ignition. There was only a thin char layer left on the surface of the sample, which means an acceptable flame retardancy. The difference between the combustion performances clearly suggests the synergistic effect between the TAI monomer and TPO photo-initiator, which could be attributed to the thermally stable isocyanurate rings in the TAI monomer and the sufficient level of phosphorus containing structure of the TPO molecule.

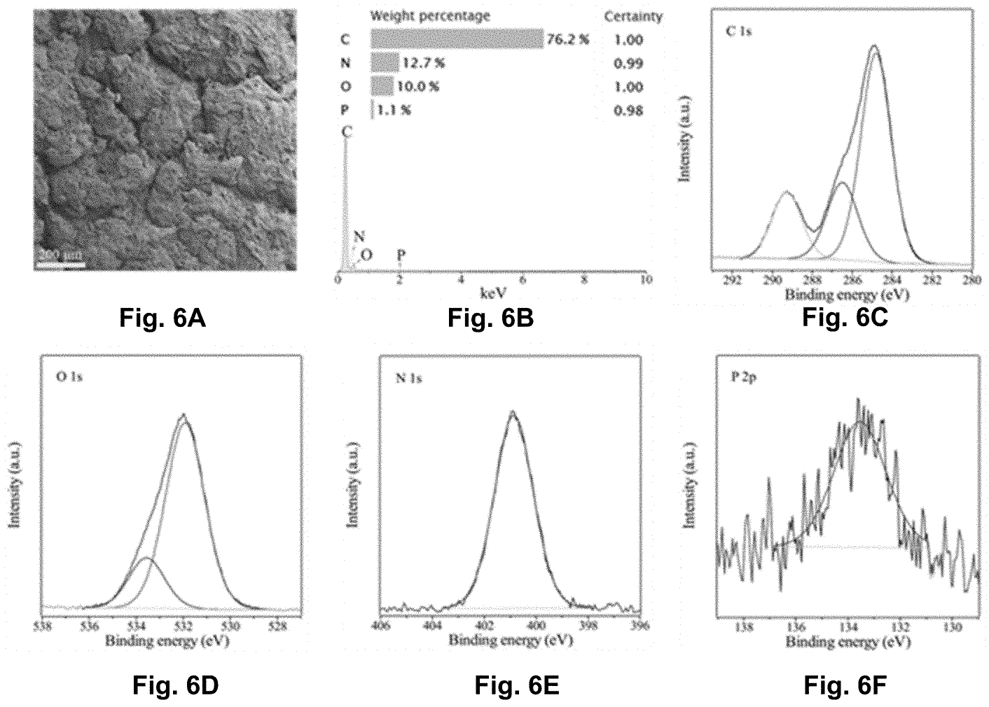

The SEM, Energy Dispersive Spectroscopy (EDS), and X-ray photoelectron spectroscopy (XPS) characterizations for the char residue of the HTSMP were conducted to explore the flame-retardant mechanism. As shown in FIG. 6A, an intact and continuous char structure can be observed, indicating that the high yield char can be a protective layer and barrier in condensed phase that slowed down the degradation. The peaks ascribed to phosphorus and nitrogen elements in the EDS spectrum confirmed their presence in the char residue, which suggests the condensed-phase mechanism (FIG. 6B). XPS spectra of the char residue were recorded to explore the condensed-phase mechanism in detail (FIGS. 6C-6F). The high-resolution XPS spectra of each elements display the surface chemistry and the bonding characteristics. The C 1s peaks centered at 284.8 eV, 286.4 eV and 289.3 eV are attributed to C—C/C—H of the aliphatic and aromatic species, C—O group and C═O group, respectively [45]. The 01s spectrum displays two peaks, the one at 531.9 eV is attributed to the P═O or C═O groups, and the other at a binding energy of 533.6 eV is assigned to C—O—C structure [45]. The N1s spectrum shows only one peak that centered at 400.8 eV, which is attributed to the stable C—N bond in six-membered ring in isocyanurate species [46]. The single peak in P 2p spectrum at 133.6 eV is assigned to P═O structure in the decomposed char residue [47]. Based on the findings regarding the thermal stability and evolution of the molecular structures during combustion, we propose that the thermally stable isocyanurate and phosphine oxide structures contribute to the formation of intact protective char layer, which can delay the thermal decomposition and prevent the heat transfer from combustion area to the substrate, as well as slow down the escape of combustible pyrolysis volatiles in reducing the fire hazard of the HTSMP.

In summary, an intrinsically flame-retardant HTSMP with T_{g} of 280° C. was successfully designed and synthesized by applying an excess amount of commercially available photo-initiator TPO into a UV curable isocyanurate based triacrylate monomer. Benefitted from thermally stable triazine ring, the UV cured sample can be further thermally post-cured at 280° C. for 3 h to achieve the complete polymerization and the final highly-crosslinked network. This UV-thermal two-step curing process makes it easy to fabricate complicated structures through 3D printing by digital light processing technology. The post-cured HTSMP exhibited higher mechanical properties and thermal stability in both inert and air atmospheres. Importantly, derived from the promising high-temperature mechanical performance, the HTSMP displayed the record-high recovery stress of 35.3 MPa and energy output of 2.9 MJ/m³. In addition, the incorporation of 7 wt % TPO resulted in an acceptable flame retardancy for the HTSPM, which suggests the synergy between isocyanurate ring and phosphine oxide structures. With the ultrahigh T_{g}, record-breaking recovery stress and energy output, excellent thermal stability and intrinsic flame retardancy, we believe that this multifunctional HTSMP can achieve its full potential in practical engineering applications.

### REFERENCES

[1] H. Meng, G. Q. Li, A review of stimuli-responsive shape memory polymer composites, Polymer 54 (2013) 2199-2221.
[2] Q. Zhao, H. J. Qi, T. Xie, Recent progress in shape memory polymer: New behavior, enabling materials, and mechanistic understanding, Prog. Polym. Sci. 49-50 (2015) 79-120.
[3] T. Xie, Tunable polymer multi-shape memory effect, Nature 464 (2010) 267-270.
[4] X. M. Feng, J. Z. Fan, A. Li, G. Q. Li, Biobased Tannic Acid Cross-Linked Epoxy Thermosets with Hierarchical Molecular Structure and Tunable Properties: Damping, Shape Memory, and Recyclability, ACS Sustain. Chem. Eng. 8 (2020) 874-883.
[5] A. Lendlein, H. Y. Jiang, O. Junger, R. Langer, Light-induced shape-memory polymers, Nature 434 (2005) 879-882.
[6] H. Y. Du, J. H. Zhang, Solvent induced shape recovery of shape memory polymer based on chemically cross-linked poly(vinyl alcohol), Soft Matter 6 (2010) 3370-3376.
[7] A. M. Schmidt, Electromagnetic activation of shape memory polymer networks containing magnetic nanoparticles, Macromol. Rapid Commun. 27 (2006) 1168-1172.
[8] Q. J. Ze, X. Kuang, S. Wu, J. Wong, S. M. Montgomery, R. D. Zhang, J. M. Kovitz, F. Y. Yang, H. J. Qi, R. K. Zhao, Magnetic Shape Memory Polymers with Integrated Multifunctional Shape Manipulation, Adv. Mater. 32 (2020) 1906657.
[9] J. S. Leng, H. B. Lv, Y. J. Liu, S. Y. Du, Synergic effect of carbon black and short carbon fiber on shape memory polymer actuation by electricity, J. Appl. Phys. 104 (2008) 104917.
[10] Y. J. Liu, H. B. Lv, X. Lan, J. S. Leng, S. Y. Du, Review of electro-active shape-memory polymer composite, Compos. Sci. Technol. 69 (2009) 2064-2068.
[11] N. Zheng, Z. Z. Fang, W. K. Zou, Q. Zhao, T. Xie, Thermoset Shape-Memory Polyurethane with Intrinsic Plasticity Enabled by Transcarbamoylation, Angew. Chem. Int. Edit. 55 (2016) 11421-11425.
[12] T. Defize, R. Riva, J. M. Raquez, P. Dubois, C. Jerome, M. Alexandre, Thermoreversibly Crosslinked Poly(epsilon-caprolactone) as Recyclable Shape-Memory Polymer Network, Macromol. Rapid Commun. 32 (2011) 1264-1269.
[13] W. Zhang, L. Chen, Y. Zhang, Surprising shape-memory effect of polylactide resulted from toughening by polyamide elastomer, Polymer 50 (2009) 1311-1315.
[14] Y. J. Liu, H. Y. Du, L. W. Liu, J. S. Leng, Shape memory polymers and their composites in aerospace applications: a review, Smart Mater. Struct. 23 (2014) 023001.
[15] M. Magzoub, S. Salehi, G. Li, J. Fan, C. Teodoriu, Loss circulation prevention in geothermal drilling by shape memory polymer, Geothermics 89 (2021) 101943.
[16] S. Y. Lu, I. Hamerton, Recent developments in the chemistry of halogen-free flame retardant polymers, Prog. Polym. Sci. 27 (2002) 1661-1712.
[17] X. M. Feng, W. Y. Xing, L. Song, Y. Hu, In situ synthesis of a MoS2/CoOOH hybrid by a facile wet chemical method and the catalytic oxidation of CO in epoxy resin during decomposition, J. Mater. Chem. A 2 (2014) 13299-13308.
[18] X. M. Feng, J. Z. Fan, A. Li, G. Q. Li, Multireusable Thermoset with Anomalous Flame-Triggered Shape Memory Effect, ACS Appl. Mater. Inter. 11 (2019) 16075-16086.
[19] W. N. Du, Y. Jin, S. Q. Lai, L. J. Shi, Y. C. Shen, H. Yang, Multifunctional light-responsive graphene-based polyurethane composites with shape memory, self-healing, and flame retardancy properties, Compos. Part A-Appl. S. 128 (2020) 105686.
[20] P. Miaudet, A. Derre, M. Maugey, C. Zakri, P. M. Piccione, R. Inoubli, P. Poulin, Shape and temperature memory of nanocomposites with broadened glass transition, Science 318 (2007) 1294-1296.
[21] J. Z. Fan, G. Q. Li, High enthalpy storage thermoset network with giant stress and energy output in rubbery state, Nat. Commun. 9 (2018) 642.
[22] H. Venkatesan, J. M. Chen, H. Y. Liu, Y. Kim, S. Na, W. Liu, J. L. Hu, Artificial spider silk is smart like natural one: having humidity-sensitive shape memory with superior recovery stress, Mater. Chem. Front. 3 (2019) 2472-2482.
[23] L. Lu, J. Z. Fan, G. Q. Li, Intrinsic healable and recyclable thermoset epoxy based on shape memory effect and transesterification reaction, Polymer 105 (2016) 10-18.
[24] X. F. Li, L. C. Wang, Z. Y. Zhang, D. Y. Kong, X. L. Ao, X. L. Xiao, Electroactive High-Temperature Shape Memory Polymers with High Recovery Stress Induced by Ground Carbon Fibers, Macromol. Chem. Phys. 220 (2019) 1900164.
[25] C. D. Wick, A. J. Peters, G. Li, Quantifying the contributions of energy storage in a thermoset shape memory polymer with high stress recovery: a molecular dynamics study, Polymer 213 (2021) 123319.
[26] C. Yan, G. Li, A Mechanism-Based Four-Chain Constitutive Model for Enthalpy-Driven Thermoset Shape Memory Polymers With Finite Deformation, J. Appl. Mech. 87 (2020) 061007.
[27] U. Quittmann, L. Lecamp, W. El Khatib, B. Youssef, C. Bunel, Synthesis of a new phosphonated dimethacrylate: Photocuring kinetics in homo- and copolymerization, determination of thermal and flame-retardant properties, Macromol. Chem. Phys. 202 (2001) 628-635.
[28] G. Ribera, L. A. Mercado, M. Galia, V. Cadiz, Flame retardant epoxy resins based on diglycidyl ether of isobutyl bis(hydroxypropyl)phosphine oxide, J. Appl. Polym. Sci. 99 (2006) 1367-1373.
[29] A. Li, J. Z. Fan, G. Q. Li, Recyclable thermoset shape memory polymers with high stress and energy output via facile UV-curing, J. Mater. Chem. A 6 (2018) 11479-11487.
[30] Y. Nakamura, M. Yamaguchi, K. Iko, M. Okubo, T. Matsumoto, Internal-Stress of Epoxy-Resin Modified with Acrylic Polymers Containing Functional-Groups Produced by Insitu Uv-Radiation Polymerization, Polymer 31 (1990) 2066-2070.
[31] M. Wen, L. E. Scriven, A. V. McCormick, Differential scanning calorimetry and cantilever deflection studies of polymerization kinetics and stress in ultraviolet curing of multifunctional (meth)acrylate coatings, Macromolecules 35 (2002) 112-120.
[32] E. L. Kirkby, J. D. Rule, V. J. Michaud, N. R. Sottos, S. R. White, J. A. E. Manson, Embedded shape-memory alloy wires for improved performance of self-healing polymers, Adv. Funct. Mater. 18 (2008) 2253-2260.
[33] N. Lakhera, C. M. Yakacki, T. D. Nguyen, C. P. Frick, Partially constrained recovery of (meth)acrylate shape-memory polymer networks, J. Appl. Polym. Sci. 126 (2012) 72-82.
[34] R. Yu, X. Yang, Y. Zhang, X. J. Zhao, X. Wu, T. T. Zhao, Y. L. Zhao, W. Huang, Three-Dimensional Printing of Shape Memory Composites with Epoxy-Acrylate Hybrid Photopolymer, ACS Appl. Mater. Inter. 9 (2017) 1820-1829.
[35] C. Likitaporn, P. Mora, S. Tiptipakorn, S. Rimdusit, Recovery stress enhancement in shape memory composites from silicon carbide whisker-filled benzoxazine-epoxy polymer alloy, J. Intel. Mat. Syst. Str. 29 (2018) 388-396.
[36] K. Gall, M. L. Dunn, Y. P. Liu, G. Stefanic, D. Balzar, Internal stress storage in shape memory polymer nanocomposites, Appl. Phys. Lett. 85 (2004) 290-292.
[37] S. A. R. Hashmi, H. C. Prasad, R. Abishera, H. N. Bhargaw, A. Naik, Improved recovery stress in multi-walled-carbon-nanotubes reinforced polyurethane, Mater. Design 67 (2015) 492-500.
[38] M. Yoonessi, Y. Shi, D. A. Scheiman, M. Lebron-Colon, D. M. Tigelaar, R. Weiss, M. A. Meador, Graphene polyimide nanocomposites; thermal, mechanical, and high-temperature shape memory effects, ACS nano 6 (2012) 7644-7655.
[39] X. Xiao, D. Kong, X. Qiu, W. Zhang, F. Zhang, L. Liu, Y. Liu, S. Zhang, Y. Hu, J. Leng, Shape-memory polymers with adjustable high glass transition temperatures, Macromolecules 48 (2015) 3582-3589.
[40] Y. Shi, R. A. Weiss, Sulfonated Poly(ether ether ketone) Ionomers and Their High Temperature Shape Memory Behavior, Macromolecules 47 (2014) 1732-1740.
[41] F. Xie, L. N. Huang, Y. J. Liu, J. S. Leng, Synthesis and characterization of high temperature cyanate-based shape memory polymers with functional polybutadiene/acrylonitrile, Polymer 55 (2014) 5873-5879.
[42] X. L. Chen, Y. Hu, L. Song, C. Jiao, Preparation and thermal properties of a novel UV-cured star polyurethane acrylate coating, Polym. Advan. Technol. 19 (2008) 322-327.
[43] X. M. Feng, W. Y. Xing, J. J. Liu, S. L. Qiu, Y. Hu, K. M. Liew, Reinforcement of organo-modified molybdenum disulfide nanosheets on the mechanical and thermal properties of polyurethane acrylate films, Compos. Sci. Technol. 137 (2016) 188-195.
[44] A. C. Weems, J. K. Carrow, A. K. Gaharwar, D. J. Maitland, Improving the Oxidative Stability of Shape Memory Polyurethanes Containing Tertiary Amines by the Presence of Isocyanurate Triols, Macromolecules 51 (2018) 9078-9087.
[45] C. Y. Bo, Z. Y. Shi, L. H. Hu, Z. Pan, Y. Hu, X. H. Yang, P. Y. Jia, X. L. Ren, M. Zhang, Y. H. Zhou, Cardanol derived P, Si and N based precursors to develop flame retardant phenolic foam, Sci. Rep. 10 (2020) 12082.
[46] S. Khanal, W. P. Zhang, S. Ahmed, M. Ali, S. A. Xu, Effects of intumescent flame retardant system consisting of tris (2-hydroxyethyl) isocyanurate and ammonium polyphosphate on the flame retardant properties of high-density polyethylene composites, Compos. Part A-Appl. S. 112 (2018) 444-451.
[47] X. M. Feng, X. Wang, W. Cai, S. L. Qiu, Y. Hu, K. M. Liew, Studies on Synthesis of Electrochemically Exfoliated Functionalized Graphene and Polylactic Acid/Ferric Phytate Functionalized Graphene Nanocomposites as New Fire Hazard Suppression Materials, ACS Appl. Mater. Inter. 8 (2016) 25552-25562.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

What is claimed is:

1. A high-temperature shape memory photopolymer (HTSMP) comprising:
polyacrylate and a phosphorus containing photo-initiator (TPO), wherein the polyacrylate is polymerized by UV exposure of an acrylate monomer and the TPO, and wherein the HTSMP comprises about 5 wt % to 15 wt % of TPO.

2. The high-temperature shape memory photopolymer according to claim 1, wherein the acrylate monomer comprises a thermally stable isocyanurate structure.

3. The high-temperature shape memory photopolymer according to claim 1, wherein the acrylate monomer is an isocyanurate triacrylate.

4. The high-temperature shape memory photopolymer according to claim 1, wherein the TPO is a phosphine oxide.

5. The high-temperature shape memory photopolymer according to claim 1, wherein the high-temperature shape memory photopolymer has a T_{g} of about 280° C.

6. The high-temperature shape memory photopolymer according to claim 1, wherein the high-temperature shape memory photopolymer has a shape recovery stress of about 35.3 MPa.

7. The high-temperature shape memory photopolymer according to claim 1, wherein the high-temperature shape memory photopolymer is a digital light processing ink.

8. The high-temperature shape memory photopolymer according to claim 1, wherein the high-temperature shape memory photopolymer is a flame retardant HTSMP.

9. The high-temperature shape memory photopolymer according to claim 1, wherein the high-temperature shape memory photopolymer has an initial decomposition temperature of greater than about 360° C.

10. The high-temperature shape memory photopolymer according to claim 1, wherein the high-temperature shape memory photopolymer has an elongation at break of about 30% to about 40%.

11. A method of making a high-temperature shape memory photopolymer comprising:
combining an acrylate monomer and a phosphorus containing photo-initiator (TPO) to form a mixture;
curing the mixture under UV light to form a polyacrylate; and
heating the polyacrylate.

12. The method of claim 11, wherein the heating is at about 280° C. for about 180 minutes.

13. The method of claim 11, wherein the heating results in complete polymerization of carbon-carbon double bonds in the acrylate monomer.

14. The method of claim 11, wherein the TPO is about 7 wt % of the mixture.
